(19) United States
(12) Patent Application Publication
(10) Pub. No.: US 2024/0250442 A1
(43) Pub. Date: Jul. 25, 2024

(54) ANTENNA APPARATUS

(71) Applicant: AGENCY FOR DEFENSE DEVELOPMENT, Daejeon (KR)

(72) Inventors: Byung Chul PARK, Daejeon (KR); Kun Sup KWON, Daejeon (KR); Jong Wan HEO, Daejeon (KR)

(21) Appl. No.: 18/133,715

(22) Filed: Apr. 12, 2023

(30) Foreign Application Priority Data
Jan. 25, 2023 (KR) 10-2023-0009694

(51) Int. Cl. H01Q 13/02; H01Q 5/392

(52) U.S. Cl. CPC H01Q 13/0216; H01Q 5/392

(57) ABSTRACT

Provided is an antenna apparatus including a waveguide that extends in a first direction, an opening portion having a corrugated shape and attached to the waveguide in a second direction different from the first direction, and a horn antenna including at least one ridge and provided in the waveguide as a structure coaxial with the waveguide.

### PRIORITY INFORMATION

This application claims the benefit of Korean Patent Application No. 10-2023-0009694, filed on Jan. 25, 2023, in the Korean Intellectual Property Office, the disclosure of which is incorporated herein by reference.

### FIELD OF THE INVENTION

The embodiments of the present disclosure generally relate to an antenna apparatus.

### DESCRIPTION OF THE RELATED ART

An antenna apparatus is a configuration that is requisite for wireless communication and may transmit information over a long distance in a form of electromagnetic waves with a predetermined frequency. In particular, for satellite communication, high gain and a feature such as beam-steering may be utilized with the antenna apparatus. To achieve high gain and beam steering capability in the antenna apparatus mounted on communication satellites, an antenna may be designed as an array. In addition, to steer the beam of the antenna apparatus designed with an array, it is advantageous for the spacing between the arrays to be half or less than the wavelength of the electromagnetic wave transmitted. To satisfy this, miniaturization of the antenna apparatus is required. Also, if it is possible to transmit signals of multiple frequency bands with a single antenna apparatus, the effect of multiple antenna apparatuses may be achieved with the single antenna apparatus. Thus, it is possible to move away from a typical method for designing for each frequency band. Although related technologies have been studied, designing considering the cutoff frequency of the waveguide limits miniaturization and makes it difficult to design impedance matching in complex structures due to the constraints of miniaturization. Accordingly, there is a desire for an antenna apparatus with a simple structure that allows miniaturization while facilitating impedance matching design.

### SUMMARY OF THE INVENTION

An aspect provides a structure for an antenna apparatus with a simple impedance matching design by enabling a miniaturization of a horn antenna, which is introduced as a coaxial structure.

Technical goals of the present disclosure are not limited to the aforementioned technical features, and other unstated technical goals may be inferred from example embodiments below.

According to an aspect, there is provided an antenna apparatus including a waveguide that extends in a first direction, an opening portion having a corrugated shape and attached to the waveguide in a second direction different from the first direction, and a horn antenna including at least one ridge and provided in the waveguide as a structure coaxial with the waveguide.

The horn antenna may be configured to pass a first signal of a relatively high frequency band.

A second signal of a frequency band lower than that of the first signal may pass through a space between the waveguide and the horn antenna.

The antenna apparatus may further include at least one first iris structure that protrudes from an outer circumferential surface of the horn antenna in a direction to the waveguide.

The first iris structure and the ridge may be provided as a plurality of first iris structures and a plurality of ridges.

The antenna apparatus may further include a conduit provided in the horn antenna as a structure coaxial with the horn antenna to pass the first signal.

The ridge may include a first portion corresponding to at least one structure recessed at a predetermined depth and formed in the first direction and a second portion of at least one side of the first portion.

The antenna apparatus may further include a second iris structure that protrudes from an inner circumferential surface of the horn antenna in a radial direction toward a central axis of the horn antenna along a plane intersecting the first direction.

The first portion and the second iris structure may be provided as a plurality of first portions and a plurality of second iris structures.

According to another aspect, there is also provided an apparatus including an antenna apparatus configured to transmit a first signal and a second signal having different frequency bands, a turnstile connected to one side of the antenna apparatus, a first polarizer configured to pass the first signal at one side of the turnstile, an ortho-mode transducer (OMT) used for feeding of the first signal at one side of the first polarizer, and a second polarizer connected to the other side of the turnstile to pass the second signal.

Details of example embodiments are included in the detailed description and drawings.

According to example embodiments of the present disclosure, it is possible to provide an antenna apparatus with a simple impedance matching design by enabling a miniaturization of a horn antenna, which is introduced as a coaxial structure. In addition, it is possible to reduce a radius of the horn antenna, thereby improving a return loss of the antenna apparatus. Also, by reducing a height of an iris structure and a number of iris structures applied, it is possible to improve the design and fabrication convenience of the antenna apparatus in terms of impedance matching design.

Effects of the present disclosure are not limited to the above-mentioned effects, and effects other than the above-mentioned effects can be clearly understood by those of ordinary skill in the art from the following descriptions.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating an antenna apparatus according to an example embodiment of the present disclosure.

FIG. 2 is a diagram illustrating different structures of an antenna apparatus according to an example embodiment of the present disclosure.

FIG. 3 is a diagram illustrating a return loss of an antenna according to an example embodiment of the present disclosure.

FIG. 4 is a diagram illustrating an iris structure for alleviating a return loss deterioration according to an example embodiment of the present disclosure.

FIG. 5 is a diagram illustrating various shapes of a waveguide of a horn antenna according to example embodiments of the present disclosure.

FIG. 6 is a graph illustrating a change in cut-off frequency based on a length of a ridge of a horn antenna according to example embodiments of the present disclosure.

FIGS. 7A, 7B, 8A, 8B, 9A, and 9B are cross-sectional perspective views illustrating a horn antenna according to example embodiments of the present disclosure.

FIGS. 10A and 10B are graphs illustrating a change in return loss based on a frequency of a horn antenna according to example embodiments of the present disclosure.

FIGS. 11A, 11B, and 11C are perspective views illustrating a cross-section of a waveguide of a horn antenna according to example embodiments of the present disclosure.

FIG. 12 illustrates an application of an antenna apparatus according to an example embodiment of the present disclosure.

### DETAILED DESCRIPTION

Terms used in embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the specification, when an element is referred to as “comprising” or “including” another element, the element should not be understood as excluding other elements so long as there is no special conflicting description, and the element may include at least one other element.

Throughout the specification, the expression “at least one of A, B, and C” may include the following meaning: A alone; B alone: C alone: both A and B together; both A and C together; both B and C together; or all three of A, B, and C together.

In describing the example embodiments, descriptions of technical contents that are well-known in the art to which the present disclosure belongs and are not directly related to the present specification will be omitted. This is to more clearly communicate without obscuring the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following example embodiments that will be described in more detail with reference to the accompanying drawings. It should be noted, however, that the present disclosure is not limited to the following example embodiments, and may be implemented in various forms. Accordingly, the example embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification.

Hereinafter, example embodiments of the present disclosure will be described with reference to the drawings.

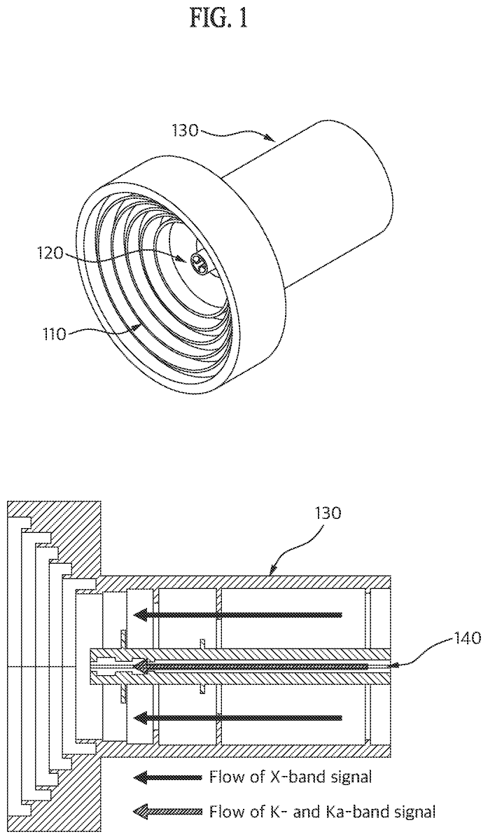

FIG. 1 is a diagram illustrating an antenna apparatus according to an example embodiment of the present disclosure.

Referring to FIG. 1, an antenna apparatus may include a waveguide 130, a corrugated opening portion 110 attached to one side surface of a waveguide for obtaining a high gain, and a horn antenna 120 that is provided in the waveguide 130 as a structure coaxial with the waveguide 130 and includes at least one ridge. The antenna apparatus may further include a conduit 140 that is provided in the horn antenna 120 as a structure coaxial with the horn antenna 120 to pass a first signal.

The antenna apparatus may pass the first signal of a relatively high frequency band through the horn antenna 120 and pass a second signal of a relatively low frequency band through a space between the waveguide 130 and the horn antenna 120. In this instance, the first signal may be a signal of a K- or Ka-band corresponding to a relatively high frequency, and the second signal may be a signal of an X-band corresponding to a relatively low frequency. Accordingly, the antenna apparatus may be used to transmit and receive signals of multiple bands.

The horn antenna may include at least one ridge. The ridge may prevent an increase in cut-off frequency, which is caused due to a miniaturization of the conduit 140 in the horn antenna. The horn antenna including the ridge will be described in detail with reference to the drawings below.

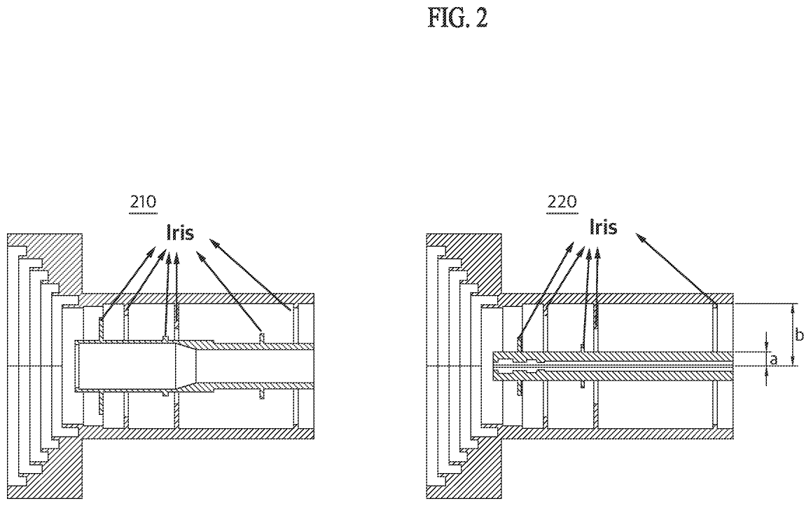

FIG. 2 is a diagram illustrating different structures of an antenna apparatus according to an example embodiment of the present disclosure.

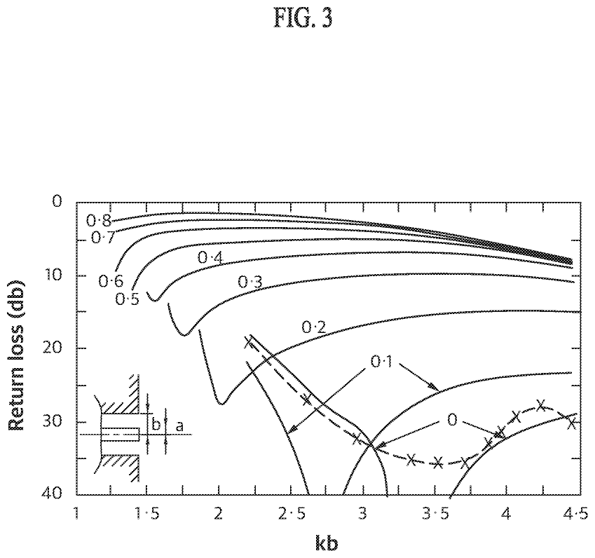

Referring to FIG. 2, an image 210 represents a case in which a non-miniaturized antenna is located in a waveguide, and an image 220 represents a case in which a ridged and miniaturized horn antenna is located in the waveguide. The antenna apparatus shown in the image 210 may be designed in consideration of a cut-off frequency of the waveguide and thus, restricted on miniaturization. In contrast, as shown in the image 220, when the ridged and miniaturized horn antenna is located in the antenna apparatus, the horn antenna that is coaxial with the waveguide may serve as a common axis. Accordingly, as shown in FIG. 3, an antenna return loss may be determined based on a ratio between a radius a from the horn antenna and a radius b from an inner circumferential surface of the waveguide.

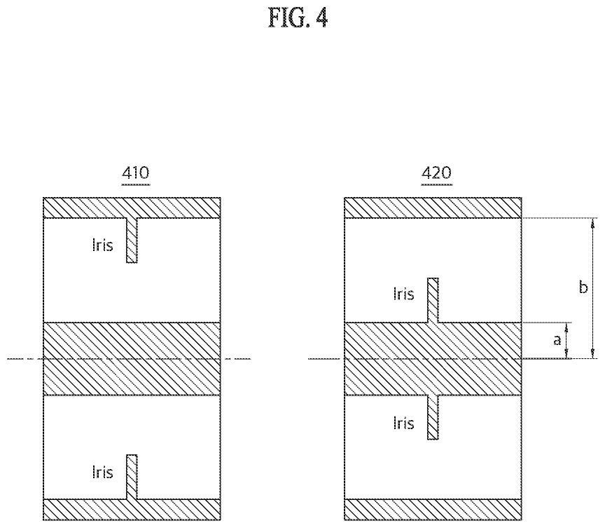

The antenna apparatus may further include at least one iris structure that protrudes from a coaxial direction to a waveguide direction. As shown in the image 210, the antenna apparatus may include, for example, six iris structures having different lengths, and as shown the image 220, the antenna apparatus may include, for example, five iris structures having different lengths. That is, by using the ridged horn antenna located in the antenna apparatus, the radius a may be reduced so a return loss of the antenna apparatus may be alleviated. Accordingly, in an impedance matching design of a plurality of iris structures as illustrated in FIG. 4, heights and/or a number of iris structures may be reduced, which may improve ease and convenience of designing and manufacturing the antenna apparatus.

FIG. 3 is a diagram illustrating a return loss of an antenna according to an example embodiment of the present disclosure.

Referring to FIG. 3, a of FIG. 3 denotes a radius from a horn antenna like the radius a of FIG. 2, and b denotes a radius of an entire antenna apparatus, which is a radius from an inner circumferential surface of a waveguide. K is a wave number, and in FIG. 3, a/b represents a return loss of 0 to 0.8. That is, as the radius a increases, the return loss of the antenna apparatus may increase. Thus, a miniaturized structure for reducing the radius a may be utilized. For example, a case in which a/b is 0.3 may correspond to the image 210, and a case in which a/b is 0.1 may correspond to the image 220. As shown in the image 220, since the ridged horn antenna may be allowed for miniaturization, the radius a may be reduced, which may alleviate the return loss of the antenna apparatus.

FIG. 4 is a diagram illustrating an iris structure for alleviating a return loss deterioration according to an example embodiment of the present disclosure.

Referring to FIG. 4, when a radius increases in an antenna apparatus, a return loss deterioration may occur. To solve this, a sophisticated impedance matching design may be embodied using a plurality of iris structures as shown in images 410 and 420. In impedance-matching designing using the plurality of iris structures of FIG. 4, the antenna apparatus as shown in the image 210 may be restricted on miniaturization so an iris impedance matching design may be embodied based on a complicated coaxial structure. In contrast, when compared to the image 210, heights and/or a number of iris structures may be reduced, which may lead to an ease of designing the antenna apparatus of the image 220.

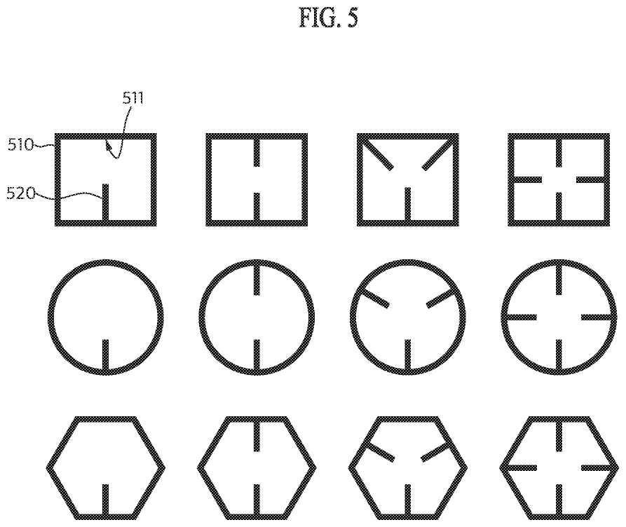

FIG. 5 is a diagram illustrating various shapes of a waveguide of a horn antenna according to example embodiments of the present disclosure.

Referring to FIG. 5, a horn antenna according to example embodiments of the present disclosure may include a waveguide 510 that has a hollow pillar shape and extends in a first direction. The waveguide 510 may have various shapes. FIG. 5 illustrates a cross-section taken by cutting the waveguide 510 along a plane orthogonal to the first direction. For example, the waveguide 510 may have a hollow polygonal column or a hollow cylindrical shape.

According to example embodiments, the waveguide 510 may be provided as a plurality of waveguides. In this instance, the plurality of waveguides 510 may be arranged in a form of an array having preset intervals (for example, designed as an array). A distance between the plurality of waveguides 510 arranged in a form of an array may be, for example, less than or equal to half a wavelength of an electromagnetic wave transmitted.

In addition, the horn antenna according to example embodiments of the present disclosure may further include at least one ridge 520 that protrudes from an inner circumferential surface (or inner wall) 511 of the waveguide 510. The ridge 520 may extend along the inner circumferential surface 511 of the waveguide 510 in the first direction. The ridge 520 may have a rectangular cross-section in view of a cross-section according to FIG. 5.

According to example embodiments, the ridge 520 may be provided as a plurality of ridges 520. In this instance, lengths in a radial direction (for example, a direction from the inner circumferential surface 511 of the waveguide 510 toward the central axis of the waveguide 510) of the ridges 520 may be substantially the same. For example, when the horn antenna includes two ridges 520, the two ridges 520 may be provided to face each other. In addition, for example, when the horn antenna includes three ridges 520, the three ridges 520 may be provided to be at an angle of about 520 degrees (°). Also, for example, when the horn antenna includes four ridges 520, the four ridges 520 may be provided to be at an angle of about 90°. In this instance, each of the ridges 520 may face another one of the ridges 520.

According to example embodiments, the horn antenna may further include a horn portion that extends from one end portion of the waveguide 510 in the first direction and has a radius increasing in the first direction (that is, having a cone shape).

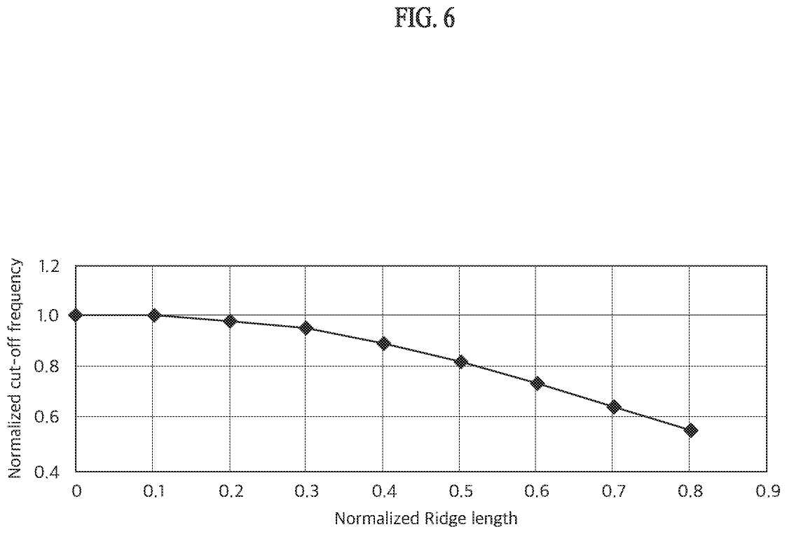

FIG. 6 is a graph illustrating a change in cut-off frequency based on a length of a ridge of a horn antenna according to example embodiments of the present disclosure.

Here, a horizontal axis represents a ratio (for example, a normalized ridge length) of a length of a ridge in a radial direction to a radius of a waveguide of a horn antenna, and a vertical axis represents a ratio (that is, a normalized cut-off frequency) of a cut-off frequency of a fundamental mode of a horn antenna including a ridge to a cut-off frequency of a horn antenna with no ridge.

FIG. 6 shows measurement results obtained for a horn antenna including four ridges and a waveguide having a hollow cylindrical shape. In the example of FIG. 6, a length of each of the ridges in a circumferential direction (for example, a rotating direction along an outer circumferential surface or inner circumferential surface of the waveguide on a plane intersecting the first direction) of the waveguide may be about 0.1 times a radius of the waveguide.

Referring to FIG. 6, as the length of the ridge in the radial direction increases, the cut-off frequency may decrease. For example, when the normalized ridge length is from about 0.7 to about 0.8 (that is, when the length of the ridge in the radial direction is from about 0.7 times to about 0.8 times the radius of the waveguide), the normalized cut-off frequency may be from about 0.5 to 0.7. Accordingly, as the length of the ridge in the radial direction increases, the horn antenna may be easily miniaturized. Through this, the miniaturized horn antenna may easily suppress unintended grating lobes during beam steering.

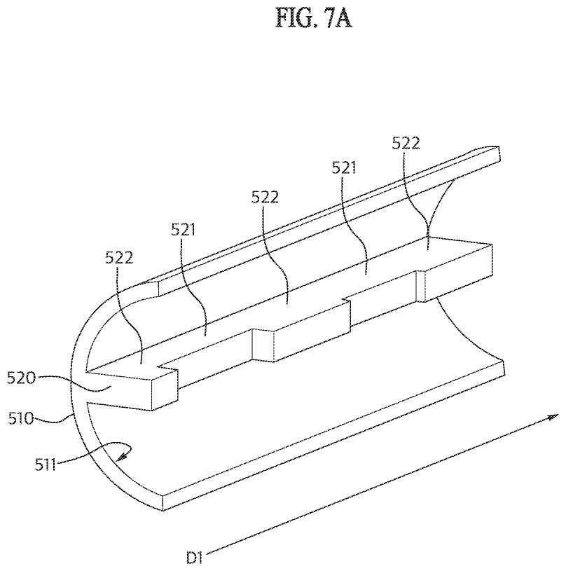

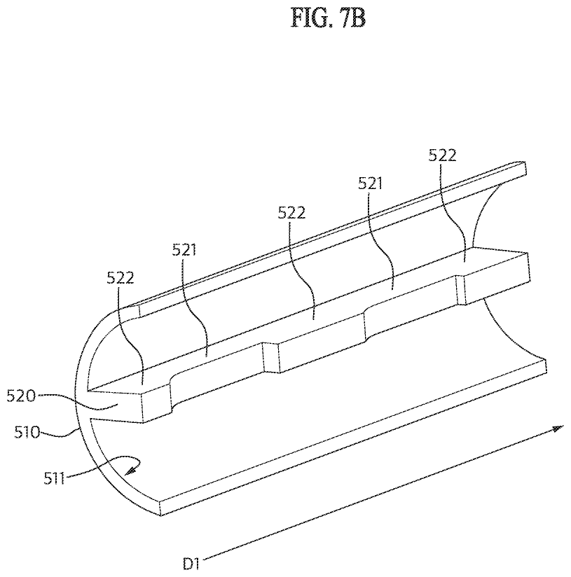

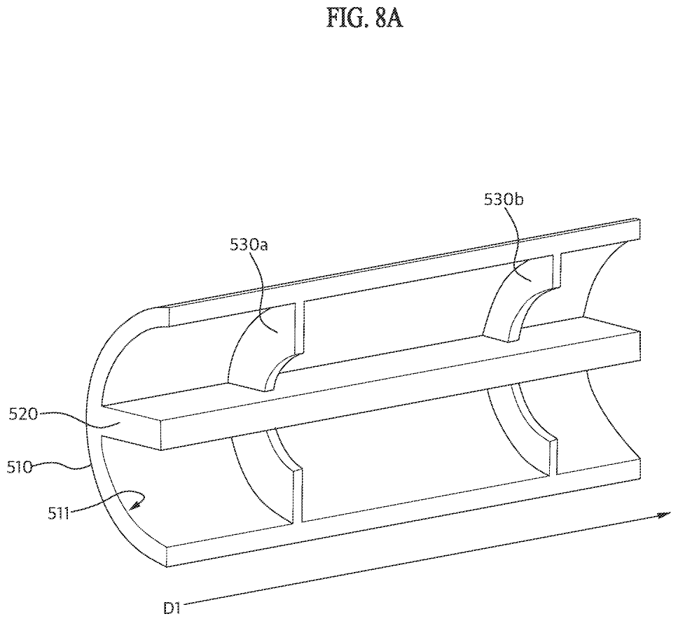

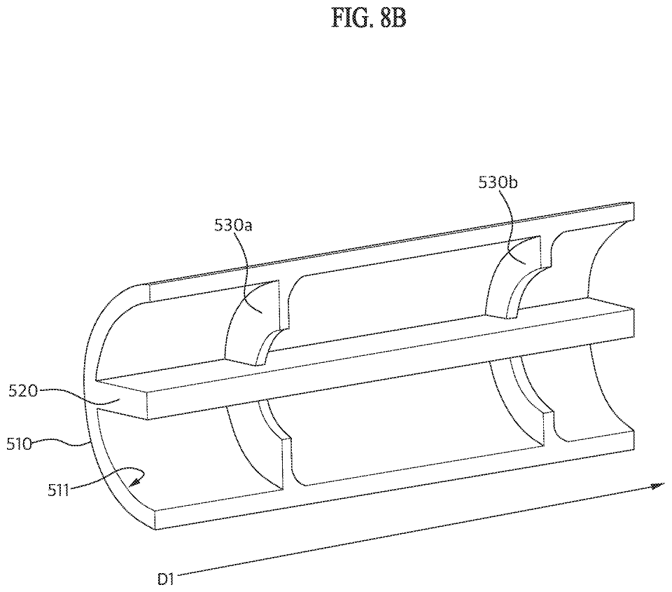

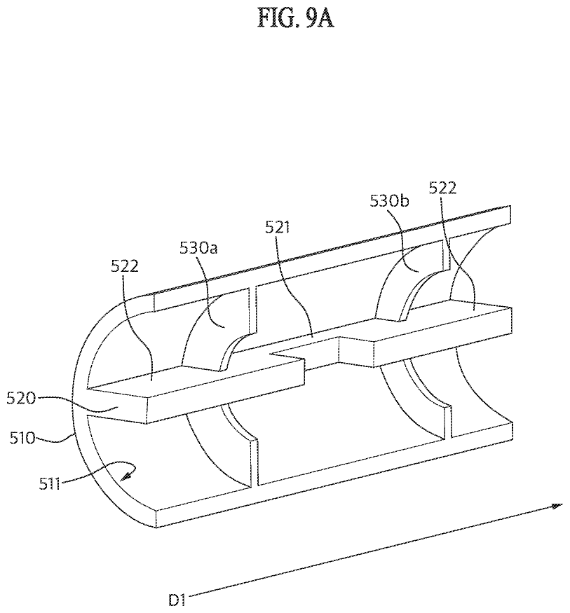

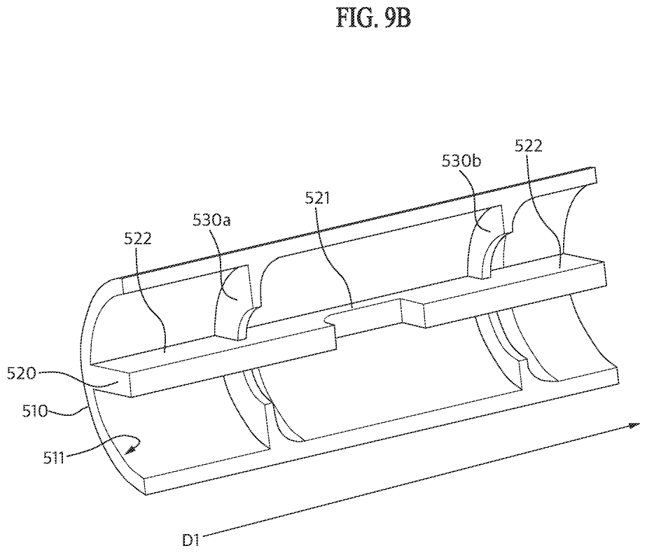

According to the example embodiments, FIGS. 7A, 7B, 8A, 8B, 9A, and 9B illustrate different impedance-matching structures related to horn antennas. FIGS. 7A and 7B illustrate a horn antenna including a ridge to which a plurality of recessed grooves are applied, FIGS. 8A and 8B illustrate a horn antenna having a plurality of iris structures, and FIGS. 9A and 9B illustrate a horn antenna obtained by combining the horn antennas of FIGS. 7A, 7B, 8A, and 8B. Hereinafter, each structure will be described in detail with reference to the corresponding drawing.

FIGS. 7A and 7B are cross-sectional perspective views illustrating a horn antenna according to example embodiments of the present disclosure. In this specification, a recessed groove may also be referred to as one of a recessed portion of the ridge 520 and a concave portion of the ridge 520.

Referring to FIGS. 7A and 7B, a horn antenna according to example embodiments of the present disclosure may include a waveguide 510 that has a hollow pillar shape and extends in a first direction D1 and a ridge 520 that protrudes from an inner circumferential surface 511 of the waveguide 510 in a radial direction of the waveguide 510 and extends in the first direction D1. In this case, the ridge 520 may have at least one recessed groove formed in the first direction D1. The recessed groove may be a portion of the ridge 520 and configured to concavely recess from a surface in a direction toward a central axis of the waveguide 510. Alternatively, the recessed groove may be a portion of the ridge 520 and configured to recess at a predetermined depth in the direction toward the central axis of the waveguide 510. In this instance, a shape of the recessed portion may be as shown in FIG. 7A or 7B. Accordingly, as shown in FIGS. 7A and 7B, due to the recessed structure, a first portion 521 and a second portion 522 may have different lengths from the inner circumferential surface 511 of the waveguide 510 in the direction toward the central axis of the waveguide 510.

The ridge 520 may include the first portion 521 and the second portion 522 at one side of the first portion 521 corresponding to at least one recessed structure formed in the first direction. A length of the first portion 521 in the radial direction may be less than a length of the second portion 522 in the radial direction. For example, the length of the second portion 522 in the radial direction may be about 0.6 times to about 0.9 times the radius of the waveguide 510, and the length of the first portion 521 in the radial direction may be less than the length of the second portion 522 in the radial direction and may be about 0.05 times to about 0.3 times the radius of the waveguide 510.

According to example embodiments, the first portion 521 having the recessed portion may be provided as a plurality of first portions 521. The first portions 521 may be spaced apart from each other in the first direction D1. The first portions 521 may have different lengths in the radial direction. That is, the first portions 521 may be recessed at different depths in the radial direction. According to example embodiments, the lengths of the first portions 521 in the radial direction may increase in the first direction D1. Each of the lengths of the first portions 521 in the radial direction may be, for example, about 0.3 times to about 0.85 times the radius of the waveguide 510. The first portions 521 may have different lengths in the first direction D1. According to example embodiments, the lengths of the first portions 521 in the first direction D1 may decrease in the first direction D1. Each of the lengths of the first portions 521 in the first direction D1 may be, for example, about 1.1 times to about 1.8 times the radius of the waveguide 510.

According to example embodiments of the present disclosure, the horn antenna may be manufactured using, for example, a three-dimensional (3D) printing method. More specifically, according to example embodiments of the present disclosure, the horn antenna may be manufactured using an additive manufacturing method. In this case, an additive manufacturing direction may be, for example, opposite to the first direction D1. Accordingly, referring to FIG. 7B, in each of the first portions 521 of the ridge 520, at least a portion of a surface in the direction toward the central axis of the waveguide 510 may have a curved shape. In other words, at least a portion of each of the first portions 521 of the ridge 520 may have a length in the radial direction which increases as being closer to the second portion 522 (that is, decreases in the first direction D1). A portion of the ridge 520 of which the length in the radial direction changes may support structures inside the waveguide 510 in an additive manufacturing process, which may increase an ease in manufacturing the horn antenna according to example embodiments of the present disclosure.

FIGS. 8A and 8B are cross-sectional perspective views illustrating a horn antenna according to example embodiments of the present disclosure. Hereinafter, for ease and convenience, content substantially the same as described with reference to FIGS. 7A and 7B will be omitted, and a difference thereof will be described in detail.

Referring to FIGS. 8A and 8B, according to example embodiments of the present disclosure, a horn antenna may include the waveguide 510 that has a hollow pillar shape and extends in the first direction D1, the ridge 520 that protrudes from the inner circumferential surface 511 of the waveguide 510 in the radial direction of the waveguide 510 and extends in the first direction D1, and iris structures 530a and 530b that protrude from the inner circumferential surface 511 of the waveguide 510 along a plane intersecting the first direction D1. That is, the iris structures 530a and 530b that protrude from the inner circumferential surface of the horn antenna in the radial direction toward the central axis of the horn antenna along the plane intersecting the first direction may be further included.

The iris structures 530a and 530b may be shaped as, for example, a ring extending along the inner circumferential surface 511 of the waveguide 510. The iris structures 530a and 530b may include the iris structure 530a and the iris structure 530b. The iris structure 530a and the iris structure 530b may be spaced apart from each other in the first direction D1.

A length of each of the iris structure 530a and the iris structure 530b in the radial direction may be less than the length of the ridge 520 in the radial direction. For example, the length of the ridge 520 in the radial direction may be about 0.6 times to about 0.9 times the radius of the waveguide 510, and the length of each of the iris structure 530a and the iris structure 530b in the radial direction may be about 0.2 times to about 0.6 times the radius of the waveguide 510.

The iris structure 530a and the iris structure 530b may have different lengths in the radial direction. For example, the length of the iris structure 530a in the radial direction may be greater than the length of the iris structure 530b in the radial direction. According to example embodiments, the lengths of the iris structures 530a and 530b in the radial direction may decrease in the first direction D1. In addition, according to example embodiments, the iris structure 530a and the iris structure 530b may have different lengths in the first direction D1.

According to example embodiments of the present disclosure, the horn antenna may be manufactured using an additive manufacturing method. In this case, an additive manufacturing direction may be, for example, opposite to the first direction D1. Accordingly, referring to FIG. 8B, each of the iris structures 530a and 530b may have at least a portion of which a length in the radial direction decreases in the first direction D1. A portion of each of the iris structures 530a and 530b of which the length in the radial direction changes may support structures inside the waveguide 510 in an additive manufacturing process, which may increase an ease in manufacturing the horn antenna according to example embodiments of the present disclosure.

FIGS. 9A and 9B are cross-sectional perspective views illustrating a horn antenna according to example embodiments of the present disclosure. Hereinafter, for ease and convenience, content substantially the same as described with reference to FIGS. 7A, 7B, 8A, and 8B will be omitted, and a difference thereof will be described in detail. In this specification, a recessed groove may also be referred to as one of a recessed portion of the ridge 520 and a concave portion of the ridge 520.

Referring to FIGS. 9A and 9B, according to example embodiments of the present disclosure, a horn antenna may include the waveguide 510 that has a hollow pillar shape and extends in the first direction D1, the ridge 520 that protrudes from the inner circumferential surface 511 of the waveguide 510 in the radial direction of the waveguide 510 and extends in the first direction D1, and the iris structures 530a and 530b that protrude from the inner circumferential surface 511 of the waveguide 510 along a plane intersecting the first direction D1. In this case, the ridge 520 may have at least one recessed groove formed in the first direction D1. The recessed groove may be a portion of the ridge 520 and configured to concavely recess from the surface in the direction toward the central axis of the waveguide 510. Alternatively, the recessed groove may be a portion of the ridge 520 and configured to recess at a predetermined depth in the direction toward the central axis of the waveguide 510. In this instance, a shape of the recessed portion may be as shown in FIG. 9A or 9B. Accordingly, as shown in FIGS. 9A and 9B, due to the recessed structure, the first portion 521 and the second portion 522 may have different lengths from the inner circumferential surface 511 of the waveguide 510 in the direction toward the central axis of the waveguide 510.

The ridge 520 may include the first portion 521 and the second portion 522 at one side of the first portion 521 corresponding to at least one recessed structure formed in the first direction. The iris structure 530a and the iris structure 530b may be spaced apart from each other in the first direction D1. Each of the iris structure 530a and the iris structure 530b may extend from a side surface of the second portion 522 of the ridge 520 in the circumferential direction of the waveguide 510. The first portion 521 of the ridge 520 may be disposed between the iris structure 530a and the iris structure 530b and spaced apart from each of the iris structure 530a and the iris structure 530b in the first direction D1.

Due to the recessed structure, the length of the first portion 521 of the ridge 520 in the radial direction may be less than the length of the second portion 522 of the ridge 520 in the radial direction. As an example, the length of the first portion 521 of the ridge 520 in the radial direction may be less than the length of each of the iris structure 530a and the iris structure 530b in the radial direction. As another example, the length of the first portion 521 of the ridge 520 in the radial direction may be less than the length of the iris structure 530a in the radial direction and greater than the length of the iris structure 530b in the radial direction. As another example, the length of the first portion 521 of the ridge 520 in the radial direction may be greater than the length of each of the iris structure 530a and the iris structure 530b in the radial direction.

According to example embodiments of the present disclosure, the horn antenna may be manufactured using an additive manufacturing method. In this case, an additive manufacturing direction may be, for example, opposite to the first direction D1. Accordingly, referring to FIG. 9B, in the first portion 521 of the ridge 520, at least a portion of a plane in the direction toward the central axis of the waveguide 510 may have a curved shape. In other words, at least a portion of the first portion 521 of the ridge 520 may have a length in the radial direction which increases as being closer to the second portion 522 (that is, decreases in the first direction D1). In addition, at least a portion of each of the iris structures 530a and 530b may have a length in the radial direction which decreases in the first direction D1.

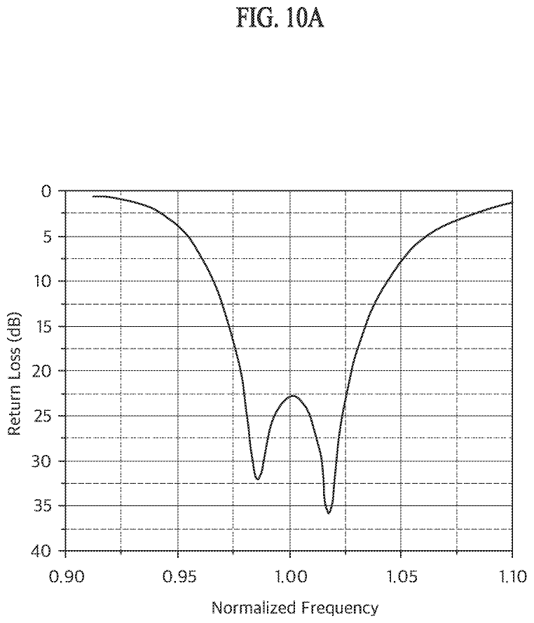

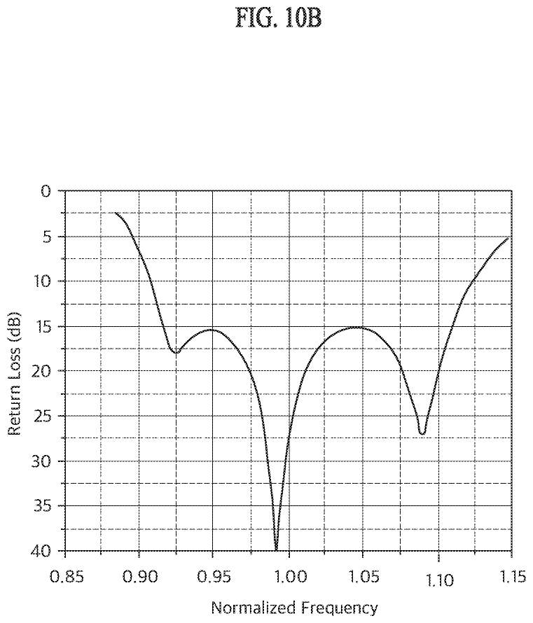

FIGS. 10A and 10B are graphs illustrating a change in return loss based on a frequency of a horn antenna according to example embodiments of the present disclosure.

In the graphs, a horizontal axis represents a ratio (that is, a normalized frequency) of a measurement frequency to a sampling frequency, and a vertical axis represents a return loss. The return loss may be represented in units of decibels (dB).

FIG. 10A shows measurement results obtained in a case in which each of a sum of a number of recessed grooves described with reference to FIGS. 7A and 7B and a sum of a number of iris structures described with reference to FIGS. 8A and 8B each are two (that is, a two-stage impedance matching structure). FIG. 10B shows measurement results obtained in a case in which a sum of the number of recessed grooves and the number of iris structures is three that is, a three-stage impedance matching structure) as described with reference to FIGS. 9A and 9B.

Referring to FIGS. 10A and 10B, in the case of the two-stage impedance matching structure, the graph has two peaks, and in the case of the three-stage impedance matching structure, the graph has three peaks. Accordingly, a bandwidth of the three-stage impedance matching structure (about 20%) may be greater than that of the two-stage impedance matching structure (about 8%) based on the return loss of about 15 dB. In other words, as the number (that is, the number of stages) of the impedance matching structures increases, the return loss of the horn antenna according to an example embodiment of the present disclosure may decrease, and thus the bandwidth may increase.

Accordingly, the horn antenna according to example embodiments of the present disclosure may not only achieve high-power transmission, but also possess broadband characteristics resulting from an increased number of impedance matching structures so it may be used as an antenna array for military satellite communications or as an antenna for radar/electronic warfare systems. A military satellite including the horn antenna according to example embodiments of the present disclosure may increase a transmission capacity through an application of frequency band expansion and high-order modulation schemes. As a result, they can maintain excellent communication quality even in adverse radio wave environments, ensuring information exchange between surveillance and reconnaissance systems, command and control systems, precision strike systems, and tactical maneuvers. As a result, an excellent communication quality may be maintained even in an adverse radio wave environment while ensuring surveillance and reconnaissance, command and control, information exchange between precision strike systems, and command and control between tactical maneuvers.

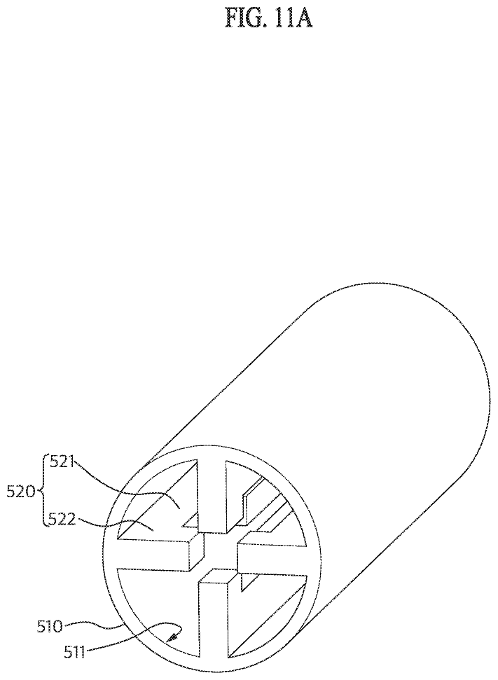

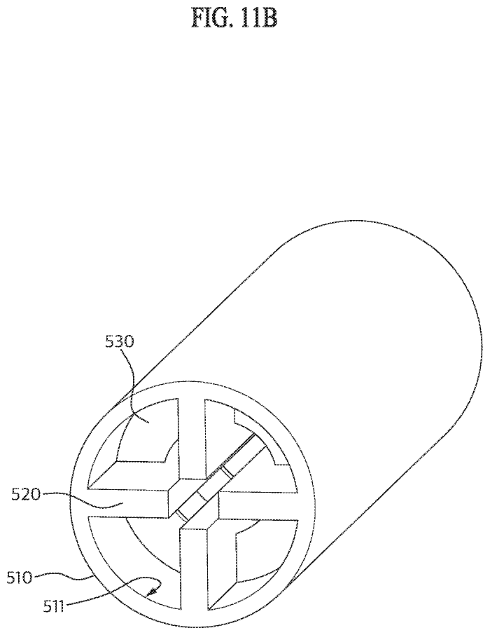

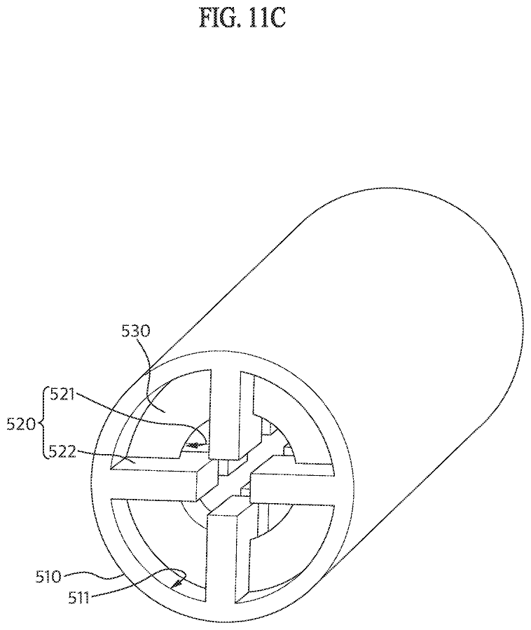

FIGS. 11A, 11B, and 11C are perspective views illustrating a cross-section of a waveguide of a horn antenna according to example embodiments of the present disclosure. Hereinafter, for ease and convenience, content substantially the same as described with reference to FIGS. 7A, 7B, 8A, 8B, 9A, and 9B will be omitted, and a difference thereof will be described in detail.

FIGS. 11A, 11B, and 11C illustrate various types of miniaturized horn antennas having ridges and disposed in an antenna apparatus. The horn antennas with the ridges may correspond to an impedance matching structure using a plurality of recesses on an inside ridge according to impedance non-matching due to miniaturization (as shown in FIG. 11A), a matching structure using an iris structure (as shown in FIG. 11B), and a matching structure based on a combination of a recess and an iris structure (as shown in FIG. 11C).

Referring to FIGS. 11A, 11B, and 11C, the horn antenna may include the waveguide 510 extending in the first direction and four ridges 520 protruding from the inner circumferential surface 511 of the waveguide 510 in the radial direction of the waveguide 510. In this case, each of the ridges 520 may have at least one recessed groove formed in the first direction D1. In other words, each of the ridges 520 may include the first portion 521 having the recessed groove and the second portion 522 at one side of the first portion 521. In this instance, the recessed portions of the ridges 520 may be provided to be symmetric based on the central axis of the waveguide 510. For example, the first portion 521 of one of the ridges 520 may face the first portion 521 of another one of the ridges 520 facing one of the ridges 520. The horn antenna may further include an iris structure 530 that protrudes from the inner circumferential surface 511 of the waveguide 510 along a plane intersecting the first direction D1. Each of the recessed groove and the iris structure 530 may serve as an inductor or capacitor in circuitry, and according to this, the impedance non-matching due to the miniaturization of the horn antenna may be solved.

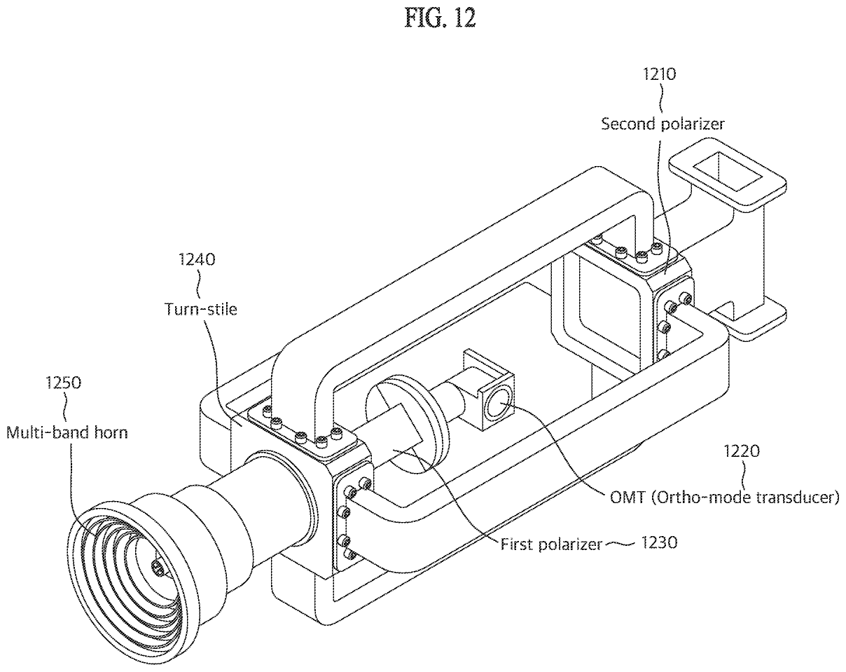

FIG. 12 illustrates an application of an antenna apparatus according to an example embodiment of the present disclosure.

Referring to FIG. 12, a multi-band horn 1250 transmitting a first signal and a second signal of different frequency bands may correspond to an antenna apparatus. A turnstile 1240 may be connected to one side of the multi-band horn 1250. A first polarizer 1230 for circularly polarizing the first signal of a relatively high frequency band and an ortho-mode transducer (OMT) 1220 for feeding of the first signal may be sequentially mounted on one side of the turnstile 1240. A second polarizer 1210 for polarizing the second signal of a relatively low frequency band may be mounted on the other side of the turnstile 1240. In this instance, an input port of a signal of a K- or Ka-band may be separated by the ortho-mode transducer 1220.

The implementations shown and described herein are illustrative examples of the present disclosure and are not intended to otherwise limit the scope of the present disclosure in any way. For brevity, other functional aspects of the components related to the antenna may not be described in detail. Furthermore, the connecting lines, or connectors shown in the various figures presented are intended to represent functional relationships and/or physical or logical couplings between the various elements. It should be noted that many alternative or additional functional relationships, physical connections or logical connections may be present in a practical device.

The use of the terms “a” and “an” and “the” and similar referents in the context of describing the present disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the operations of all methods described herein may be performed in any suitable order unless otherwise indicated herein or otherwise clearly contradicted by context. The present disclosure is not limited to the described order of the operations. The use of any and all examples, or language (e.g., “for example” and the like) provided herein, is intended merely to better illuminate the present disclosure and does not pose a limitation on the scope of the present disclosure unless otherwise claimed. Numerous modifications and adaptations will be readily apparent to those skilled in the art without departing from the spirit and scope of the present disclosure.

What is claimed is:

1. An antenna apparatus comprising:
a waveguide that extends in a first direction;
an opening portion having a corrugated shape and attached to the waveguide in a second direction different from the first direction; and
a horn antenna comprising at least one ridge and provided in the waveguide as a structure coaxial with the waveguide.

2. The antenna apparatus of claim 1, wherein the horn antenna transmits a first signal of a first frequency band.

3. The antenna apparatus of claim 2, wherein a second signal of a second frequency band passes through a space between the waveguide and the horn antenna.

4. The antenna apparatus of claim 3, wherein the second frequency band is lower than the first frequency band.

5. The antenna apparatus of claim 1, further comprising:
at least one first iris structure that protrudes from an outer circumferential surface of the horn antenna in a direction to the waveguide.

6. The antenna apparatus of claim 5, wherein the first iris structure and the ridge are provided as a plurality of first iris structures and a plurality of ridges.

7. The antenna apparatus of claim 2, further comprising:
a conduit provided in the horn antenna as a structure coaxial with the horn antenna to pass the first signal.

8. The antenna apparatus of claim 1, wherein the ridge comprises a first portion corresponding to at least one structure recessed at a predetermined depth and formed in the first direction and a second portion of at least one side of the first portion.

9. The antenna apparatus of claim 8, further comprising:
a second iris structure that protrudes from an inner circumferential surface of the horn antenna in a radial direction toward a central axis of the horn antenna along a plane intersecting the first direction.

10. The antenna apparatus of claim 9, wherein the first portion and the second iris structure are provided as a plurality of first portions and a plurality of second iris structures.

11. An apparatus comprising:
an antenna apparatus that transmits a first signal and a second signal having different frequency bands;
a turnstile connected to one side of the antenna apparatus;
a first polarizer that passes the first signal at one side of the turnstile;
an ortho-mode transducer (OMT) used for feeding of the first signal at one side of the first polarizer; and
a second polarizer connected to the other side of the turnstile to pass the second signal.
